(19) United States
(12) Patent Application Publication
(10) Pub. No.: US 2025/0377870 A1
(43) Pub. Date: Dec. 11, 2025

(54) Identifying Source Code from Automatically Built System Images

(71) Applicant: Kodem Security Ltd., Tel Aviv (IL)

(72) Inventors: Or CASTEL DUBINCHIK, Tel Aviv (IL); Binyamin SHARET, Modi'in (IL); Pavel FURMAN, Netanya (IL)

(21) Appl. No.: 18/735,854

(22) Filed: Jun. 6, 2024

(51) Int. Cl. G06F 8/41

(52) U.S. Cl. CPC G06F 8/41

(57) ABSTRACT

A method of identifying a source code repository (SCR) of a given system image (SI) as an originating SCR, comprising: a) providing an operating environment initialized from the given system image, and a plurality of SCRs; b) identifying one or more SI files as created in a final stage of a system image build; c) selecting one or more of the identified SI files, and determining, for each of the selected SI files, a respective file path and one or more respective file characteristics, thereby constituting an SI fingerprint; d) determining respective degrees of correlation between the SI fingerprint and respective SCR fingerprints of each of the plurality of SCRs; and e) identifying at least one SCR as an originating SCR based on the determined respective degrees of correlation.

### TECHNICAL FIELD

The presently disclosed subject matter relates to use of automated software deployment tools, and in particular to tracing source code within such systems.

### BACKGROUND

Problems of implementation in systems of automated software system deployment have been recognized in the conventional art, and various techniques have been developed to provide solutions.

### GENERAL DESCRIPTION

According to one aspect of the presently disclosed subject matter there is provided a computer-implemented method identifying a source code repository (SCR) of a given system image (SI) as an originating SCR, the software module being associated with a first application framework, the method comprising:
a) providing an operating environment initialized from the given system image, and a plurality of SCRs, wherein at least one SCR includes one or more source code files that were utilized to build the given SI;
b) identifying one or more SI files as created in a final stage of a system image build, each SI file being a file comprised in the given SI;
c) selecting one or more of the identified SI files, and determining, for each of the selected SI files, a respective file path and one or more respective file characteristics,
the respective file paths and respective file characteristics of the selected SI files thereby constituting an SI fingerprint;
d) determining respective degrees of correlation between the SI fingerprint and respective SCR fingerprints of each of the plurality of SCRs, wherein each SCR fingerprint comprises, for one or more of the source code files included in the SCR: a respective file path and one or more respective file characteristics; and
e) identifying at least one SCR as an originating SCR, based on the determined respective degrees of correlation.

In addition to the above features, the system according to this aspect of the presently disclosed subject matter can comprise one or more of features (i) to (xi) listed below, in any desired combination or permutation which is technically possible:
(i) the identifying one or more SI files as created in the final stage of the system image build comprises:
   identifying a terminating subset (TS) of the SI files,
   the TS being a subset of the SI files, wherein every SI file that is not in the TS is associated with a file creation time that is earlier than the earliest file creation time of an SI file that is within the TS, the TS being associated with a TS file count;
and the selecting one or more of the identified SI files comprises:
   a) determining, for each file in the TS:
      a respective file path and one or more respective file characteristics, the file paths and respective file characteristics thereby constituting a candidate system image fingerprint;
   b) determining respective degrees of correlation between the candidate system image fingerprint and fingerprints of one or more SCRs of the plurality of SCRs, wherein each SCR fingerprint comprises, for one or more files included in the SCR: a respective file path and one or more respective file characteristics;
   c) responsive to at least one respective degree of correlation meeting a correlation criterion, selecting the SI files of the TS.
(ii) the identifying one or more SI files as created in the final stage comprises:
   identifying a terminating subset (TS) of the SI files,
   the TS being a subset of the SI files, wherein every SI file that is not in the TS is associated with a file creation time that is earlier than the earliest file creation time of an SI file that is within the TS,
   wherein, for each file of the TS, a time difference between:
      (i) a creation time associated with the file, and
      (ii) a creation time associated with a file of the TS with the next-earliest associated creation time,
   is less than a creation time gap threshold, and
   wherein a time difference between:
      (i) a creation time associated with the file, and
      (ii) a creation time associated with any SI file not in the TS,
   meets the creation time gap threshold,
and the selecting one or more of the identified SI files comprises selecting the SI files of the TS.
   (iii) one or more file characteristics of files of the image fingerprint are selected from a list consisting of:
      a. a size of the file,
      b. a digest of the file,
      c. a global symbol contained in the file, and
      d. a function symbol contained in the file.
   (iv) The method additionally comprising, before a):
responsive to a retrieving of a system image from an image repository by an operating environment initialization tool, obtaining access to the system image.
   (v) the determining respective degrees of correlation is based on, at least:
   a file characteristic of a file of an SCR fingerprint matching a file characteristic of a file of the image fingerprint, wherein the file path of the file of image fingerprint is in correspondence with the file path of the file of the SCR fingerprint.
      (vi) the file characteristic is a file size or file digest value.
      (vii) the file characteristic is a global symbol or function symbol.
      (viii) determining respective degrees of correlation is based on, at least:
   a file extension of a file path of an SCR fingerprint being indicative of a source code file associated with a transformative build process, and
   a file name of a corresponding file path of the image fingerprint matching a file name of the file path of the SCR fingerprint.
      (ix) the transformative build process is compilation.
      (x) the transformative build process is compression.
      (xi) wherein the transformative build process is obfuscation.

According to another aspect of the presently disclosed subject matter there is provided a system of identifying a source code repository (SCR) of a given system image (SI) as an originating SCR, the system comprising a processing circuitry (PC) configured to:
a) provide an operating environment initialized from the given SI, and a plurality of SCRs, wherein at least one SCR includes one or more source code files that were utilized to build the given SI;
b) identify one or more SI files as created in a final stage of a system image build, each SI file being a file comprised in the given SI;
c) select one or more of the identified SI files, and determine, for each of the selected SI files, a respective file path and one or more respective file characteristics,
the respective file paths and respective file characteristics of the selected SI files thereby constituting an SI fingerprint;
d) determine respective degrees of correlation between the SI fingerprint and respective SCR fingerprints of each of the plurality of SCRs, wherein each SCR fingerprint comprises, for one or more of the source code files included in the SCR: a respective file path and one or more respective file characteristics; and
e) identify at least one SCR as an originating SCR based on the determined respective degrees of correlation.

In addition to the above features, the system according to this aspect of the presently disclosed subject matter can comprise one or more of features (i) to (xi) listed below, in any desired combination or permutation which is technically possible.

According to another aspect of the presently disclosed subject matter there is provided a computer program product comprising a computer readable non-transitory storage medium containing program instructions, which program instructions when read by a processing circuitry, cause the processing circuitry to perform a method of identifying a source code repository (SCR) of a given system image (SI) as an originating SCR, the method comprising:
a) providing an operating environment initialized from the given system image, and a plurality of SCRs, wherein at least one SCR includes one or more source code files that were utilized to build the given SI;
b) identifying one or more SI files as created in a final stage of a system image build, each SI file being a file comprised in the given SI;
c) selecting one or more of the identified SI files, and determining, for each of the selected SI files, a respective file path and one or more respective file characteristics, the respective file paths and respective file characteristics of the selected SI files thereby constituting an SI fingerprint;
d) determining respective degrees of correlation between the SI fingerprint and respective SCR fingerprints of each of the plurality of SCRs, wherein each SCR fingerprint comprises, for one or more of the source code files included in the SCR: a respective file path and one or more respective file characteristics; and
e) identifying at least one SCR as an originating SCR based on the determined respective degrees of correlation.

In addition to the above features, the product according to this aspect of the presently disclosed subject matter can comprise one or more of features (i) to (xi) listed above, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an example software application deployment environment employing instantiation of system images, in accordance with some embodiments of the presently described subject matter;

FIG. 2 illustrates a logical block diagram of an example system of identifying a source code repository as being an originating source code repository of a given system image, in accordance with some embodiments of the presently described subject matter;

FIG. 3 illustrates an example image build file, in accordance with some embodiments of the presently described subject matter;

FIG. 4 illustrates a flow diagram of an example method of creating a source code repository fingerprint, in accordance with some embodiments of the presently described subject matter;

FIG. 5 illustrates a flow diagram of an example method of identifying a source code repository as an originating source code repository of a given system image, in accordance with some embodiments of the presently described subject matter;

FIG. 6 illustrates a flow diagram of an example method of selecting system image files for constructing a system image fingerprint, in accordance with some embodiments of the presently described subject matter; and

FIG. 7 illustrates a flow diagram of an example alternative method of identifying a source code repository as an originating source code repository of a given system image, in accordance with some embodiments of the presently described subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “encrypting”, “decrypting”, “determining”, “calculating”, “receiving”, “providing”, “obtaining”, “emulating” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

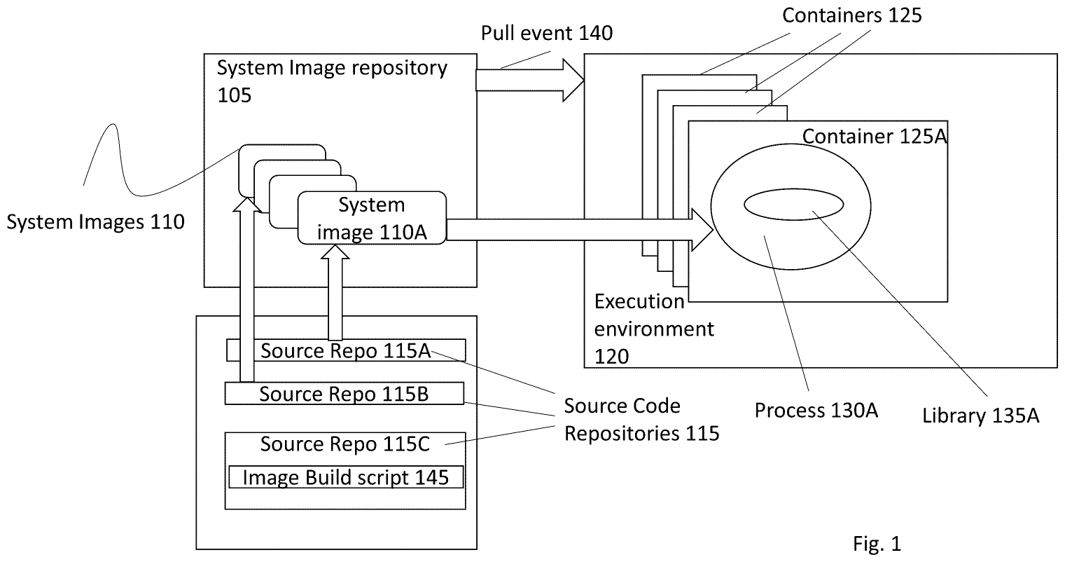

Attention is directed to FIG. 1, which illustrates an example deployment of a system image creation and deployment system, in accordance with some embodiments of the presently disclosed subject matter.

Execution environment 120 can be a system or group of systems handling computing workloads. By way of non-limiting example, execution environment 120 can be one or more physical or virtual servers (e.g. cloud-based servers) or a serverless cloud-based computing environment.

Containers 125 (by way of non-limiting example: containers of the Linux™ operating system) can execute on execution environment 120. A container such as container 125A can execute a workload e.g. an application such as process 130A, which in turn can include a statically linked or dynamically-linked library 135A. The containers 125 can be instantiated and managed—for example—using a container management system such as Kubernetes™, or via another method.

System images 110 can reside, for example, in a system image repository 105.

A system image 110A can be, for example, an ordered collection of root filesystem changes and corresponding execution parameters for use within a container runtime.

System image 110A can encapsulate an application and its dependencies, so that it includes everything needed to run the application, including (for example): code, runtime objects, libraries, and system tools.

In some examples, system image 110A is composed of one or more “layers”, where each “layer” represents a set of file changes or configurations added to the image. In some such examples, system image 110A contains a union of layered filesystems stacked on top of each other.

A system image 110A can be created by an image building system such as Docker™, as will be described in more detail below.

The container management system can initialize a new active container of containers 125 e.g. from a system image of system images 110. More specifically, a container management system such as Kubernetes™ can perform a “pull” 140 of e.g. system image 110A to execution environment 120, and then initiate a new container which then executes the application and system environment of system image 110A.

Managing and instantiating applications in this fashion can enable administrators to ensure that, for example, workloads execute in compatible and secure environments.

Accordingly, an administrator can create or obtain various system images 110 and store them to system image repository 105. An administrator can utilize an image creation tool such as Docker™, or some other mechanism, to create system images.

Source code of software modules can reside in various source repositories 115A 115B 115C. These can be located for example in a private location or a public location such as GitHub.

A source repository 115A, 115B, and 115C can include one or more image build scripts 145, which can be utilized by an image building system such as Docker™ to create system images, as will be described in more detail below. In the example of Docker™, the image build script is known as the Dockerfile.

In software system deployments such as the example described above, bugs, security issues, performance issues, or other issues can arise, which necessitate identification of the source code which gave rise to a particular runtime environment.

In these environments, using system images and managed containers, it can, however, be difficult to make this determination, i.e. to identify the specific source code that was used to create a particular environment. One approach is to include a digital “tag” in the system image which has a particular format and semantics which aid or enable identification of the source repository. This method can be cumbersome and error-prone, and is not usable in cases where originators of the image did not already apply a tag to the system image, or where the semantics of the tag are not available.

Some embodiments of the presently disclosed subject matter include a method of creating “fingerprints” of both system images and code repositories, and a method of correlating between the system images and code repositories. In this manner it is possible to identify originating source code quickly and reliably.

It is noted that while the above description pertains to management of containers, some embodiments of the presently disclosed subject matter can identify e.g. source code of applications, software packages, and/or modules executing in virtual machines instead of, or in addition to, containers.

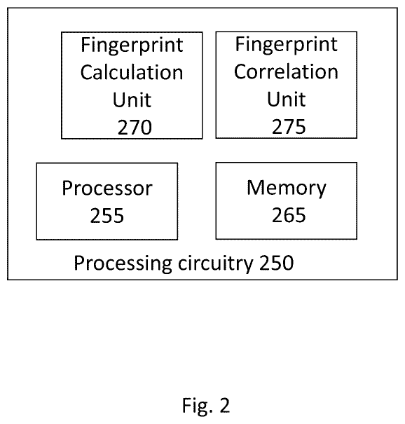

FIG. 2 illustrates an example system of identifying an originating source code repository of a system image, in accordance with some embodiments of the presently disclosed subject matter.

Processing circuitry 250 can be a system of monitoring execution environment 120. Processing circuitry 250 can be located e.g. inside execution environment 120 (e.g. in a container, virtual machine etc.), or can run outside of execution environment 120 and receive information from within execution environment 120.

Processing circuitry 250 can include processor 255 and memory 265.

Processor 255 can be a suitable hardware-based electronic device with data processing capabilities, such as, for example, a general-purpose processor, digital signal processor (DSP), a specialized Application Specific Integrated Circuit (ASIC), one or more cores in a multicore processor, etc. Processor 255 can also consist, for example, of multiple processors, multiple ASICs, virtual processors, combinations thereof etc.

Memory 265 can be, for example, a suitable kind of volatile and/or non-volatile storage, and can include, for example, a single physical memory component or a plurality of physical memory components. Memory 265 can also include virtual memory. Memory 265 can be configured to, for example, store various data used in computation.

Processing circuitry 250 can be configured to execute several functional modules in accordance with computer-readable instructions implemented on a non-transitory computer-readable storage medium. Such functional modules are referred to hereinafter as comprised in the processing circuitry. These modules can include, for example, fingerprint calculation unit 270, and fingerprint correlation unit 275.

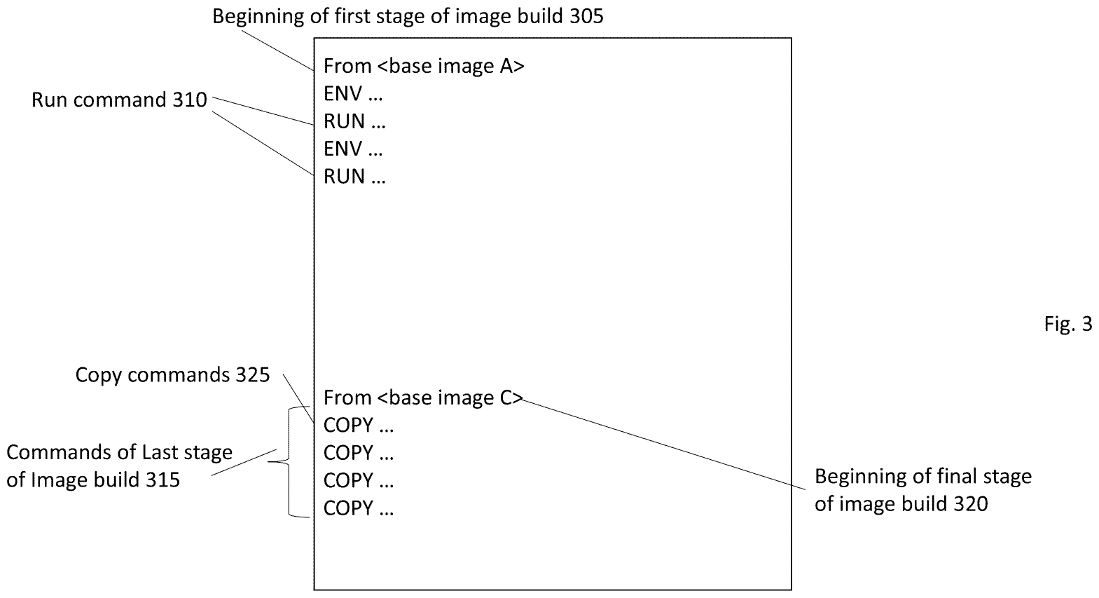

FIG. 3 illustrates an example of an image build script 145, in accordance with some embodiments of the presently disclosed subject matter.

For clarity of explanation, the syntax of the non-limiting example image build script shown in FIG. 3 is similar to the syntax of Dockerfile used by Docker™.

In some examples, image build script 145 can define a “multi-stage build”. In a multi-stage build, one or more intermediate images can be created to help build the final image. A “stage” of a build is thus interpreted to include a phase of the build sequence which begins with creation of a new image.

Image build script 145 can begin with a FROM command 305 which specifies creation of a first intermediate image, based on a different pre-created image that is termed the “base image”.

By way of non-limiting example: an administrator can specify that the first container should be built on a particular release of the Alpine™ distribution of the Linux™ (i.e. use Alpine as a base image). The administrator can accordingly specify the Docker™ command “FROM alpine:3.10” at the beginning of image build script 145.

The administrator can then specify various commands to e.g. install other software onto the first intermediate image. By way of non-limiting example: the administrator can specify Docker™ RUN commands 310 to install external source code modules, compile the sources to executable files, run installation scripts etc.

In this manner, the administrator can, by way of non-limiting example, specify utilization of the first intermediate image to build e.g. application libraries and executable files.

The administrator can subsequently specify creation 320 of a “final” image, which is also based on a pre-created based image. Build commands 315 performed to this image can be termed as the last stage of a multi-stage build. The administrator can specify e.g. Docker™ COPY commands 325, which can, by way of non-limiting example: a) copy files from previously-created intermediate (i.e. previous stages) images into the final image b) copy files from a local system (e.g. files built from a local copy of a source code repository) into the final image. In this manner, unneeded files from previous images are not incorporated into the final image.

An image build tool such as by Docker™ can then create a system image from the files and state of the final image.

It is noted that the final stage of the multistage build can include build commands which copy files from a local copy of source code repository 115C (e.g. located on a build system) to the last intermediate image. These files are then, for example, included in the system image.

It is noted that, in the multistage build sequence described here, the first stage prepares infrastructure and can utilize source code from source code repositories other than the repository that includes image build script 145. It is further noted that, in other examples of build sequences, any number of build stages can be present, and that the build stages can prepare infrastructure and/or utilize source code from source code repositories other than the repository that includes image build script 145.

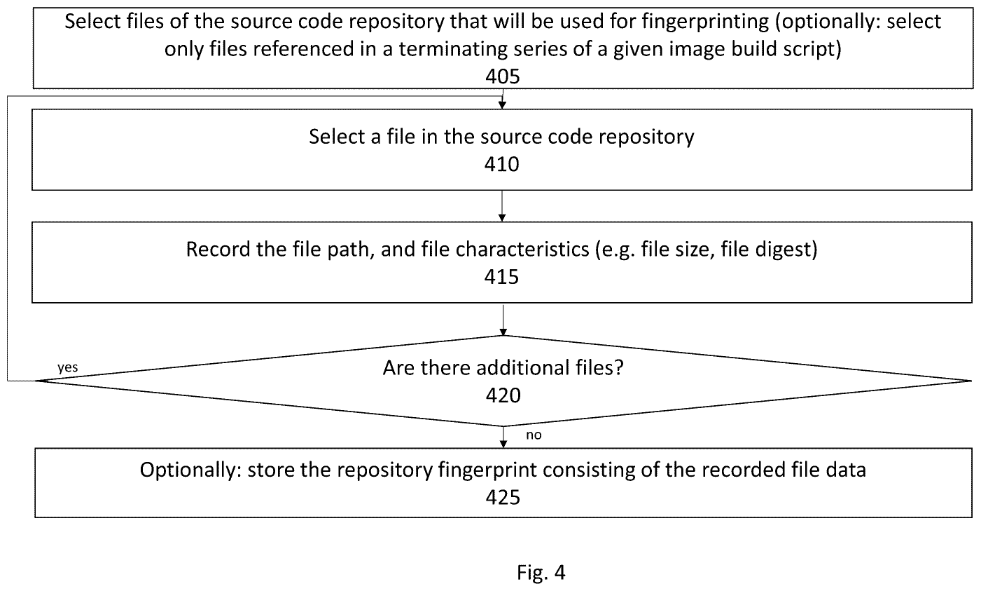

Attention is directed to FIG. 4 which illustrates a flow diagram of an example method of creating a fingerprint of a source code repository, in accordance with some embodiments of the presently disclosed subject matter.

Processing circuitry 150 (e.g. fingerprint calculation unit 270) can select 405 a set of files in a given source code repository 115C that it will use to create the fingerprint.

In some examples, processing circuitry 150 (e.g. fingerprint calculation unit 270) utilizes all files in the source code repository 115C. In some examples, processing circuitry 150 (e.g. fingerprint calculation unit 270) utilizes a subset of the files in the source code repository 115C to create the source code repository fingerprint.

In some examples, processing circuitry 150 (e.g. fingerprint calculation unit 270) first identifies an image build script file 145 in the source code repository 115C, and then identifies the commands of the final stage of the build (as described above with reference to FIG. 2). From the identified commands, processing circuitry 150 (e.g. fingerprint calculation unit 270) can identify files of source code repository 115C which were incorporated into the image and compute the repository fingerprint from these files only.

To create the fingerprint, processing circuitry 150 (e.g. fingerprint calculation unit 270) can select 410 a first file of the source code repository 115C (i.e. from the group of files that will be used to fingerprint), and can then e.g. record 415 the file path and one or more file characteristics.

In some examples, processing circuitry 150 (e.g. fingerprint calculation unit 270) records the entire file path in the source code repository. In some other examples, processing circuitry 150 (e.g. fingerprint calculation unit 270) records part of the file path (e.g. relative to an application directory in the repository). In some other examples, processing circuitry 150 (e.g. fingerprint calculation unit 270) records only the file name portion of the file path.

By way of non-limiting example, processing circuitry 150 (e.g. fingerprint calculation unit 270) can record:
The size of the file (e.g. in bytes)
A digest of the file (e.g. a hash of the file created utilizing a given hash function)
A full or partial list of global symbols contained in the file (e.g. files containing a particular programming language)
A full or partial list of functions or modules contained in the file (e.g. files containing a particular programming language).

Processing circuitry 150 (e.g. fingerprint calculation unit 270) can then evaluate 420 whether there are additional selected files, and, if so, record the path and file characteristics. The recorded file paths and file characteristics can thereby constitute a source code repository fingerprint.

Optionally: processing circuitry 150 (e.g. fingerprint calculation unit 270) can store 420 data indicative of or derivative of the source code repository fingerprint.

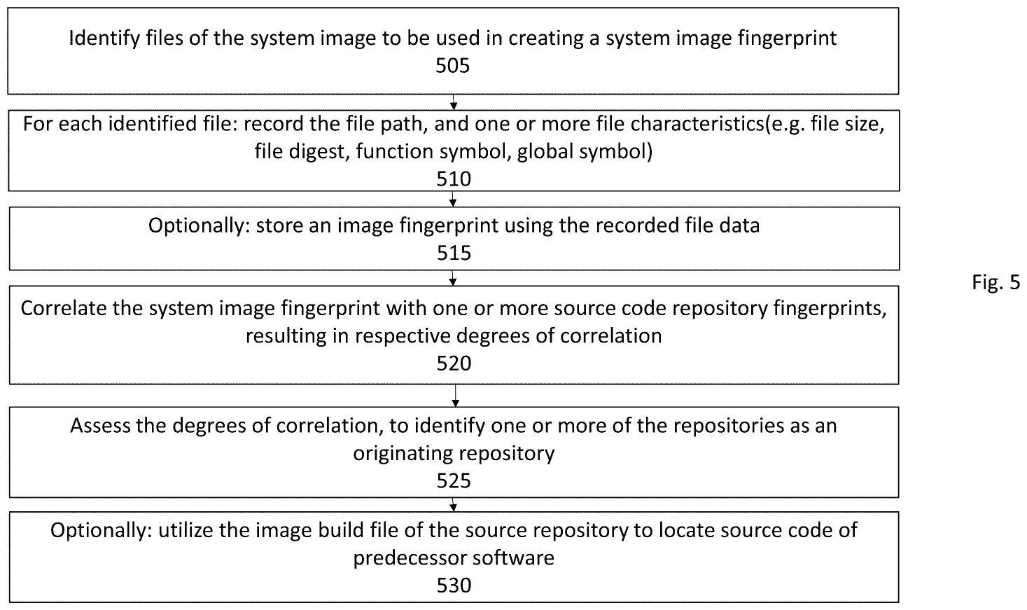

Attention is directed to FIG. 5 which illustrates a flow diagram of an example method of identifying a source code repository (of a plurality of repositories) as an originating source code repository of a given system image, in accordance with some embodiments of the presently disclosed subject matter.

As described hereinabove with reference to FIG. 2, an originating source code repository can be replicated on a build system. Moreover, the replicated originating source code repository can include an image build script 145 that is used (in combination with source code files of the repository, as well as possibly e.g. sources/objects from other repositories) to build a system image 110A. It is noted that in some examples, image build script 145 can be located external to the replicated originating source code repository (e.g. on a remote system), can be dynamically created, can be deleted subsequent to build completion etc.

Thus, when a user wants to identify an originating source code repository of a given system image 110A, he/she will—in some examples—intend to identify the repository which was replicated on the build system, and from which the image was then built.

It is noted however, that the actual originating source code repository may no longer exist, or it may have been moved, mirrored, cloned etc.

Thus, it is often sufficient to—for example—identify a source code repository including source code files that are identical with (or functionally identical to) the source code files used to build a system image 110A.

Accordingly, the term “originating source code repository” is herein interpreted to include a source code repository that includes source code files that are identical to (or functionally identical to) the source code files and image build script 145 used to build a system image 110A.

Processing circuitry 150 (e.g. fingerprint calculation unit 270) can begin by identifying 505 a plurality of files included in the system image 110A that are to be used in creating a system image fingerprint.

As described above, with reference to FIG. 2, the build process that creates system image 110A can consist of multiple stages (for example: when the image build script 145 defines a multi-stage build). As described above, in such circumstances, the source code files of the final stage can be resident in the originating source code repository.

Accordingly, in some embodiments, processing circuitry 150 (e.g. fingerprint calculation unit 270) attempts to identify the files of the system image 110A that are derivative of the final stage of the build, and use these to create a system image fingerprint. In this manner, the system image fingerprint can be based entirely or substantially on the files that are in the originating source code repository. In some other embodiments, processing circuitry 150 (e.g. fingerprint calculation unit 270) identifies files to be utilized in creation of a system image fingerprint by some other suitable method or criterion.

In some examples, system image 110A includes data indicative of all file paths included in the system image. In some examples, system image 110A includes the file path data in the order of file creation, or with associated file creation times.

In some other examples, processing circuitry 150 (e.g. fingerprint calculation unit 270) can obtain file paths of system image 110A by, for example, unpacking the layers included in system image 110A, or by cataloging the files present in a container initiated from system 110A, and then ordering them sequentially according to their creation time.

In some examples, system image file 110A can include indications that particular files are derivative of the final build stage. In such embodiments, processing circuitry 150 (e.g. fingerprint calculation unit 270) can simply identify the files derivative of the final build stage from these indications.

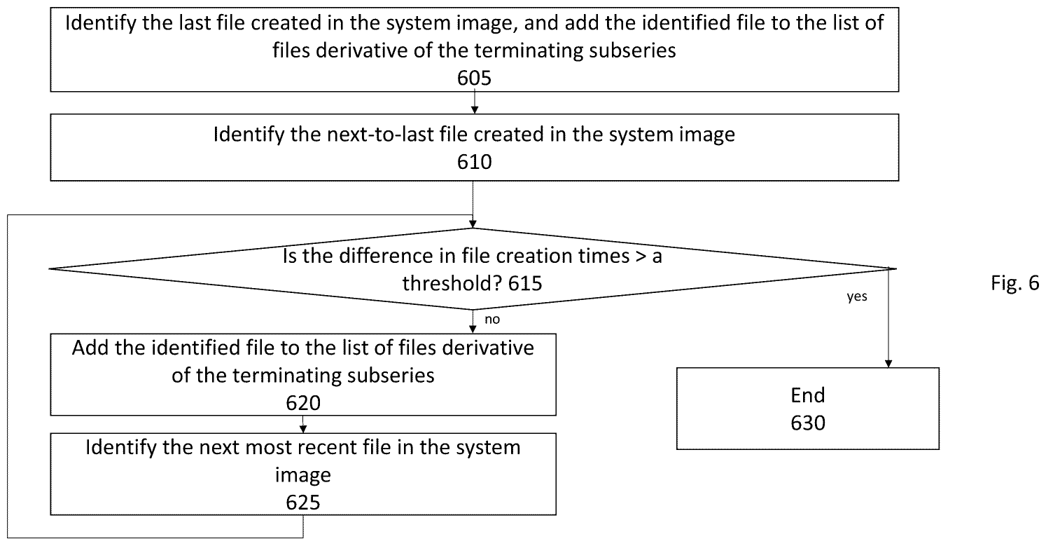

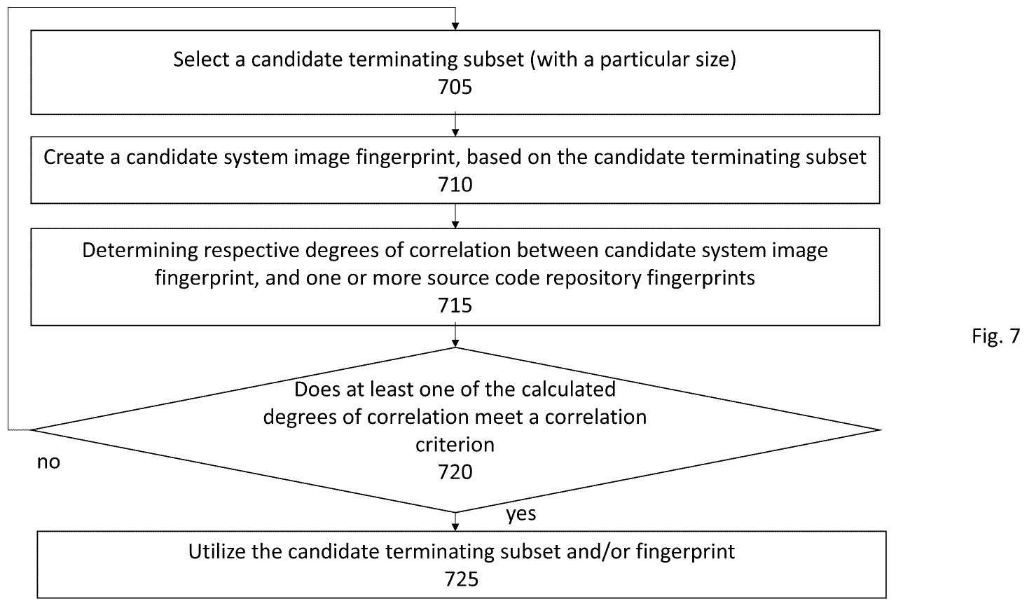

In some other examples, however, such indications are not present in system image file 110A. Consequently, other methods of identifying the files created in the final build stage (i.e. likely copied from a source code repository instance that included the image build script) can be utilized. Examples of such methods are described below, with reference to FIGS. 6-7.

In some embodiments, processing circuitry 150 (e.g. fingerprint calculation unit 270) identifies a “terminating subset” of the files included in the image, to aid in identifying or estimating which of the files included in system image 110A belong to a final build stage. The term “terminating subset” is herein interpreted to include a subset of the files included in system image 110A which includes the most recently created N files (e.g. as indicated by file creation time metadata)—for some value of N. A terminating subset thus has an associated size (i.e. the number of files in the subset).

More formally, a terminating subset (TS) can be defined as:
a subset of the system image (SI) files, wherein every SI file that is not in the TS is associated with a file creation time that is earlier than the earliest file creation time of an SI file that is within the TS.

It is noted that the entire set of files included in system image 110A are thus regarded as constituting a terminating subset, as such a set satisfies this definition.

From the identified files of the container environment, processing circuitry 150 (e.g. fingerprint calculation unit 270) can next, for each identified file, record 510 the file path.

In some embodiments, processing circuitry 150 (e.g. fingerprint calculation unit 270) records the entire file path. In some other embodiments, processing circuitry 150 (e.g. fingerprint calculation unit 270) records part of the file path (e.g. relative to an application directory in the container environment). In some other embodiments, processing circuitry 150 (e.g. fingerprint calculation unit 270) records only the file name portion of the file path.

Processing circuitry 150 (e.g. fingerprint calculation unit 270) can record one or more file characteristics together with the file path. By way of non-limiting example, processing circuitry 150 (e.g. fingerprint calculation unit 270) can record:
The size of the file (e.g. in bytes)
A digest of the file (e.g. a hash of the file created utilizing a given hash function)
A full or partial list of global symbols contained in the file (e.g. in executable files, or files containing a particular programming language)
A full or partial list of functions or modules contained in the file (e.g. in executable files, or files containing a particular programming language)

When all files have been processed, processing circuitry 150 (e.g. fingerprint calculation unit 270) has recorded one or more (for example: many more) file paths of image 110A with associated file characteristics. These file paths and characteristics constitute a fingerprint of system image 110A that can be used to enable correlation with source code repositories in real time.

Processing circuitry 150 (e.g. fingerprint calculation unit 270) can optionally perform storing 515 of the fingerprint data. For example, processing circuitry 150 (e.g. fingerprint calculation unit 270) can store the fingerprint data (i.e. file path and characteristic data) as text to a fingerprint file. Alternatively processing circuitry 150 (e.g. fingerprint calculation unit 270) can store the fingerprint data in a format that is encoded and/or compressed and/or encrypted etc.

Processing circuitry 150 (e.g. fingerprint correlation unit 175) can correlate 520 the system image fingerprint with one or more source code repository fingerprints. This can result in respective degrees of correlation between the system image fingerprint and the individual source code repository fingerprints. Processing circuitry 150 (e.g. fingerprint correlation unit 175) can perform correlation using various techniques.

Generally: correlating a system image fingerprint to a repository fingerprint can consist of assessing the similarity between the respective files that each fingerprint is based on, taking into account transformations that occur during a build process. In some embodiments, the correlation results in a numeric correlation score of the system image fingerprint to a particular source code repository fingerprint. In some other embodiments, the degree of correlation is represented in a different fashion.

More specifically: performing the correlation can include, for one or more file paths (e.g. each file path) of the system image fingerprint:
a) identifying, from the source code repository fingerprint, a corresponding file path of the source code repository (if present)
For some file types: a file path in the source code repository fingerprint can be said to “correspond” to a file path in the image fingerprint if the filenames are the same. For example, a python file ending with “.py” which appears identically in both source code repositories and system images (as indicated by their respective fingerprints), can be said to correspond. This is because Python source code (being an interpreted language) can remain unchanged through a build process.
Some other file name extensions indicate that the build process is transformative. In a transformative build process the source code is compiled, compressed, obfuscated, or otherwise transformed before being utilized in the container environment. For example, in some examples “foo” in the container environment can derive from “foo.java” or “foo.cpp” in the repository.
Thus, for file names indicating a transformative build process, a file path in the source code repository fingerprint can be said to “correspond” to a file path in the image fingerprint if the filename of a repository file path ends with a particular file extension, and the container environment filename base portion is the same, but lacks the file extension.
Identifying a file path as corresponding can also utilize names of directories in the file path. By way of non-limiting example, in cases where a source code repository fingerprint includes more than one file name “foo.py”, processing circuitry 150 (e.g. fingerprint correlation unit 175) can compare the names of the directories in which the files reside—in order to assess correspondence.
b) determining whether the file characteristics associated with a file in the system image “match” with the file characteristics associated with a file of the repository image with a corresponding path.
For files of the system image fingerprint with file names (e.g. file extensions) indicative of a non-transformative build process, certain file characteristics associated with a corresponding file in the source code repository fingerprint, can be regarded as “matching” if the characteristics are identical, e.g.:
   file digests are identical, or
   file sizes are identical.
For files of the system image fingerprint with file names (e.g. file extensions) indicative of a non-transformative build process, certain other file characteristics associated with a corresponding file in the source code repository fingerprint, can be regarded as “matching” if the characteristics are identical, e.g.:
   global symbols in the system image file fingerprint match global symbols in the source file of the repository fingerprint, or
   function symbols in the system image file fingerprint match global symbols in the source file of the repository fingerprint.
It is noted that in calculation of a “degree of correlation” or correlation score, a match based on file size and file digest can get a higher “matching score” than a match based only on file size, etc. It is further noted that a mismatch of a file characteristic (e.g. size, digest), can be interpreted as a certain indicator of non-correlation (so that processing circuitry 150 (e.g. fingerprint correlation unit 175) would determine the degree of correlation to be zero upon detecting such a mismatch.
It is noted that, in some embodiments, determining matching between file characteristics associated with a file in the system image, and file characteristics associated with a file of the repository image, can be done in a different manner.

Next, processing circuitry 150 (e.g. fingerprint correlation unit 175) can assess 525 the degrees of correlation determined between the given system image and the respective source code repositories.

In some embodiments, if the degree of correlation of a certain source code repository meets a correlation threshold, and is higher than the next highest degree of correlation by a correlation differential threshold, then processing circuitry 150 (e.g. fingerprint correlation unit 175) can regard that source code as an originating source code repository.

In some such embodiments, the correlation differential threshold can be 0.

In some embodiments, processing circuitry 150 (e.g. fingerprint correlation unit 175) assesses the degrees of correlation determined between the given system image and the respective source code repositories in a different manner.

It is noted that processing circuitry 150 (e.g. fingerprint correlation unit 175) can identify more than one source code repository as an originating source code repository. It is noted that processing circuitry 150 (e.g. fingerprint correlation unit 175) can fail to identify any source code repository as an originating source code repository.

It is noted that after identification of the originating source code repository of a system image, it is optionally possible (either for processing circuitry 150 or for an administrator), utilizing 530 the image build script, to identify repositories of other source codes included in the system image.

Attention is directed to FIG. 6 which illustrates a flow diagram of an example method of identifying files of a system image that are derivative of a final build stage, in accordance with some embodiments of the presently disclosed subject matter.

Processing circuitry 150 (e.g. fingerprint calculation unit 270) can identify 605 the temporally last file created in the system image, for example from creation time metadata associated with the file, and add it, for example, to a list of selected files.

Processing circuitry 150 (e.g. fingerprint calculation unit 270) can next identify 610 the next-to-last file included in the system image (e.g. from creation time metadata).

Processing circuitry 150 (e.g. fingerprint calculation unit 270) can then compare the file creation times of the two files. If the difference 615 in file creation times is less than a given (e.g. configured) creation time gap threshold (e.g. 15 seconds), then, in some examples, this can attest to both files being created in the same build stage. Accordingly, processing circuitry 150 (e.g. fingerprint calculation unit 270) can then add 620 the next-to-last file to the list of selected files.

Processing circuitry 150 (e.g. fingerprint calculation unit 270) can then identify 625 the preceding i.e. next-most-recent file, and again compare its file creation time (and add the file to the list of selected files if its creation time differs from its successor by less than the creation time gap threshold). The process can continue until a creation time of a file is found to differ from its successor by a time difference which meets the creation time gap threshold. Processing circuitry 150 (e.g. fingerprint calculation unit 270) can then end 630 processing, deeming the file with a creation time differing from the creation time of its successor by the creation time gap threshold value as belonging to an earlier, non-final build stage.

It is noted that the method described in FIG. 6 is an example method of creating a terminating subset (TS) of the SI files, in which the conditions hold:
of the SI files that are not in the TS: each file is associated with a file creation time that is earlier than the file creation time of the earliest-created SI file that is within the TS (as is true of any TS)
for each file of the TS, a time difference between:
   (i) a creation time associated with the file, and
   (ii) a creation time associated with a file of the TS with the next-earliest associated creation time,
is less than the creation time gap threshold, and
time difference between:
   (i) a creation time associated with the file, and
   (ii) a creation time associated with any SI file not in the TS,
meets (i.e. meets or exceeds) the creation time gap threshold.

Attention is now directed to FIG. 7 which illustrates a flow diagram of an additional example method of identifying files of a system image that are derivative of a final build stage, in accordance with some embodiments of the presently disclosed subject matter.

The method illustrated in FIG. 7 is a variation of the method illustrated in FIG. 5.

Processing circuitry 150 (e.g. fingerprint calculation unit 270) can first select 705 a candidate terminating subset (as defined above) with a particular subset size (e.g. 1).

Processing circuitry 150 (e.g. fingerprint calculation unit 270) can next create 710 a system image fingerprint based on the files of the candidate terminating subset, e.g. using the system fingerprint creation method as described above with reference to FIG. 5.

Processing circuitry 150 (e.g. fingerprint calculation unit 270) can determine 715 respective degrees of correlation between the candidate system image fingerprint and one or more source code repository fingerprints. Correlation methods are described above, with reference to FIG. 5.

Processing circuitry 150 (e.g. fingerprint calculation unit 270) can next evaluate 720 whether at least one of the calculated degrees of correlation matches a correlation criterion. Correlation criteria are described above, with reference to FIG. 5. If at least one of the calculated degrees of correlation matches a correlation criterion, then the candidate terminating subset and/or fingerprint can be utilized in the method of FIG. 5.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A processing circuitry-based method of identifying a source code repository (SCR) of a given system image (SI) as an originating SCR, the method comprising:
a) providing an operating environment initialized from the given system image, and a plurality of SCRs, wherein at least one SCR includes one or more source code files that were utilized to build the given SI;
b) identifying one or more SI files as created in a final stage of a system image build, each SI file being a file comprised in the given SI;
c) selecting one or more of the identified SI files, and determining, for each of the selected SI files, a respective file path and one or more respective file characteristics,
the respective file paths and respective file characteristics of the selected SI files thereby constituting an SI fingerprint;
d) determining respective degrees of correlation between the SI fingerprint and respective SCR fingerprints of each of the plurality of SCRs, wherein each SCR fingerprint comprises, for one or more of the source code files included in the SCR: a respective file path and one or more respective file characteristics; and
e) identifying at least one SCR as an originating SCR based on the determined respective degrees of correlation.

2. The method of claim 1, wherein the identifying one or more SI files as created in the final stage of the system image build comprises:
identifying a terminating subset (TS) of the SI files,
the TS being a subset of the SI files, wherein every SI file that is not in the TS is associated with a file creation time that is earlier than the earliest file creation time of an SI file that is within the TS, the TS being associated with a TS file count;
and wherein the selecting one or more of the identified SI files comprises:
a) determining, for each file in the TS:
a respective file path and one or more respective file characteristics, the file paths and respective file characteristics thereby constituting a candidate system image fingerprint;
b) determining respective degrees of correlation between the candidate system image fingerprint and fingerprints of one or more SCRs of the plurality of SCRs, wherein each SCR fingerprint comprises, for one or more files included in the SCR: a respective file path and one or more respective file characteristics;
c) responsive to at least one respective degree of correlation meeting a correlation criterion, selecting the SI files of the TS.

3. The method of claim 1, wherein the identifying one or more SI files as created in the final stage comprises:
identifying a terminating subset (TS) of the SI files,
the TS being a subset of the SI files, wherein every SI file that is not in the TS is associated with a file creation time that is earlier than the earliest file creation time of an SI file that is within the TS,
wherein, for each file of the TS, a time difference between:
(i) a creation time associated with the file, and
(ii) a creation time associated with a file of the TS with the next-earliest associated creation time,
is less than a creation time gap threshold, and
wherein a time difference between:
(i) a creation time associated with the file, and
(ii) a creation time associated with any SI file not in the TS,
meets the creation time gap threshold,
and wherein the selecting one or more of the identified SI files comprises selecting the SI files of the TS.

4. The method of claim 1, wherein one or more file characteristics of files of the image fingerprint are selected from a list consisting of:
a) a size of the file,
b) a digest of the file,
c) a global symbol contained in the file, and
d) a function symbol contained in the file.

5. The method of claim 1, additionally comprising, before a):
responsive to a retrieving of a system image from an image repository by an operating environment initialization tool, obtaining access to the system image.

6. The method of claim 1, wherein the determining respective degrees of correlation is based on, at least:
a file characteristic of a file of an SCR fingerprint matching a file characteristic of a file of the image fingerprint, wherein the file path of the file of image fingerprint is in correspondence with the file path of the file of the SCR fingerprint.

7. The method of claim 6, wherein the file characteristic is a file size or file digest value.

8. The method of claim 6, wherein the file characteristic is a global symbol or function symbol.

9. The method of claim 1, wherein the determining respective degrees of correlation is based on, at least:
a file extension of a file path of an SCR fingerprint being indicative of a source code file associated with a transformative build process, and
a file name of a corresponding file path of the image fingerprint matching a file name of the file path of the SCR fingerprint.

10. The method of claim 9, wherein the transformative build process is compilation.

11. The method of claim 9, wherein the transformative build process is compression.

12. The method of claim 9, wherein the transformative build process is obfuscation.

13. A system of identifying a source code repository (SCR) of a given system image (SI) as an originating SCR, the system comprising a processing circuitry (PC) configured to:
a) provide an operating environment initialized from the given SI, and a plurality of SCRs, wherein at least one SCR includes one or more source code files that were utilized to build the given SI;
b) identify one or more SI files as created in a final stage of a system image build, each SI file being a file comprised in the given SI;
c) select one or more of the identified SI files, and determine, for each of the selected SI files, a respective file path and one or more respective file characteristics,
the respective file paths and respective file characteristics of the selected SI files thereby constituting an SI fingerprint;
d) determine respective degrees of correlation between the SI fingerprint and respective SCR fingerprints of each of the plurality of SCRs, wherein each SCR fingerprint comprises, for one or more of the source code files included in the SCR: a respective file path and one or more respective file characteristics; and
e) identify at least one SCR as an originating SCR based on the determined respective degrees of correlation.

14. A computer program product comprising a computer readable non-transitory storage medium containing program instructions, which program instructions when read by a processing circuitry, cause the processing circuitry to perform a method of identifying a source code repository (SCR) of a given system image (SI) as an originating SCR, the method comprising:
a) providing an operating environment initialized from the given system image, and a plurality of SCRs, wherein at least one SCR includes one or more source code files that were utilized to build the given SI;
b) identifying one or more SI files as created in a final stage of a system image build, each SI file being a file comprised in the given SI;
c) selecting one or more of the identified SI files, and determining, for each of the selected SI files, a respective file path and one or more respective file characteristics,
the respective file paths and respective file characteristics of the selected SI files thereby constituting an SI fingerprint;
d) determining respective degrees of correlation between the SI fingerprint and respective SCR fingerprints of each of the plurality of SCRs, wherein each SCR fingerprint comprises, for one or more of the source code files included in the SCR: a respective file path and one or more respective file characteristics; and
e) identifying at least one SCR as an originating SCR based on the determined respective degrees of correlation.
